(19) United States
(12) Patent Application Publication
(10) Pub. No.: US 2024/0406759 A1
(43) Pub. Date: Dec. 5, 2024

(54) UPLINK BEAM MEASUREMENT METHOD AND UPLINK BEAM MEASUREMENT APPARATUS

(71) Applicant: BEIJING XIAOMI MOBILE SOFTWARE CO., LTD, Beijing (CN)

(72) Inventor: Xingyi LUO, Beijing (CN)

(73) Assignee: BEIJING XIAOMI MOBILE SOFTWARE CO., LTD, Beijing (CN)

(21) Appl. No.: 18/696,605

(22) PCT Filed: Sep. 28, 2021
(86) PCT No.: PCT/CN2021/121458

§ 371 Date: Mar. 28, 2024

(51) Int. Cl. H04W 24/02; H04B 17/318; H04L 5/00; H04W 72/231

(52) U.S. Cl. CPC H04W 24/02; H04B 17/318; H04L 5/0051; H04W 72/231

(57) ABSTRACT

An uplink beam measurement method and includes: receiving configuration information, where the configuration information includes a sounding reference signal (SRS) corresponding to a non-serving cell.

### CROSS REFERENCE TO RELATED APPLICATION

The present application is a U.S. National Stage of International Application No. PCT/CN2021/121458, filed on Sep. 28, 2021, the entire content of which is incorporated herein by reference for all purposes.

### BACKGROUND

In a scene of inter-cell mobility in a communication system or inter-cell multi-transmission reception points (TRPs), service can be provided for a terminal device by a non-serving cell.

### SUMMARY

In a first aspect, an example of the disclosure provides a method for measuring an uplink beam. The method is performed by a terminal device. The method includes: receiving configuration information, where the configuration information includes a sounding reference signal (SRS) corresponding to a non-serving cell.

In a second aspect, an example of the disclosure provides another method for measuring an uplink beam. The method is performed by a network device. The method includes: transmitting configuration information, where the configuration information includes a sounding reference signal (SRS) corresponding to a non-serving cell.

In a third aspect, an example of the disclosure provides a communication apparatus. The communication apparatus includes a processor and a memory. The memory stores computer programs. When the processor executes the computer programs, the communication apparatus performs the method according to the first aspect.

In a fourth aspect, an example of the disclosure provides a communication apparatus. The communication apparatus includes a processor and a memory. The memory stores computer programs. When the processor executes the computer programs, the communication apparatus performs the method according to the second aspect.

In a fifth aspect, an example of the disclosure provides a communication apparatus. The apparatus includes a processor and an interface circuit. The interface circuit is configured to receive code instructions and transmit the code instructions to the processor. The processor is configured to execute the code instructions such that the apparatus performs the method according to the first aspect.

In a sixth aspect, an example of the disclosure provides a communication apparatus. The apparatus includes a processor and an interface circuit. The interface circuit is configured to receive code instructions and transmit the code instructions to the processor. The processor is configured to execute the code instructions such that the apparatus performs the method according to the second aspect.

In a seventh aspect, an example of the disclosure provides a non-transitory computer-readable storage medium. The computer-readable storage medium is configured to store instructions used by the terminal device. When the instructions are executed, the method according to the first aspect is implemented.

In an eighth aspect, an example of the disclosure provides a non-transitory computer-readable storage medium. The computer-readable storage medium is configured to store instructions used by the network device. When the instructions are executed, the method according to the second aspect is implemented.

### BRIEF DESCRIPTION OF DRAWINGS

In order to more clearly describe technical solutions in examples of the disclosure or the background art, the accompanying drawings required for the examples of the disclosure or the background art will be illustrated below.

FIG. 1 is a schematic diagram of a framework of a communication system according to an example of the disclosure;

FIG. 2 is a schematic flow diagram of a method for measuring an uplink beam according to an example of the disclosure;

FIG. 3 is a schematic flow diagram of a method for measuring an uplink beam according to another example of the disclosure;

FIG. 4 is a schematic flow diagram of a method for measuring an uplink beam according to yet another example of the disclosure;

FIG. 5 is a schematic flow diagram of a method for measuring an uplink beam according to yet another example of the disclosure;

FIG. 6 is a schematic flow diagram of a method for measuring an uplink beam according to yet another example of the disclosure;

FIG. 7 is a schematic flow diagram of a method for measuring an uplink beam according to yet another example of the disclosure;

FIG. 8 is a schematic flow diagram of a method for measuring an uplink beam according to yet another example of the disclosure;

FIG. 9 is a schematic flow diagram of a method for measuring an uplink beam according to yet another example of the disclosure;

FIG. 10 is a schematic flow diagram of a method for measuring an uplink beam according to yet another example of the disclosure;

FIG. 11 is a schematic flow diagram of a method for measuring an uplink beam according to yet another example of the disclosure;

FIG. 12 is a schematic flow diagram of a method for measuring an uplink beam according to yet another example of the disclosure;

FIG. 13 is a schematic flow diagram of a method for measuring an uplink beam according to yet another example of the disclosure;

FIG. 14 is a schematic flow diagram of a method for measuring an uplink beam according to still another example of the disclosure;

FIG. 15 is a schematic structural diagram of a communication apparatus according to an example of the disclosure;

FIG. 16 is a schematic structural diagram of a communication apparatus according to another example of the disclosure; and

FIG. 17 is a schematic structural diagram of a chip according to an example of the disclosure.

### DETAILED DESCRIPTION

Examples will be described in detail here and shown in the accompanying drawings illustratively. When the following descriptions involve the accompanying drawings, unless otherwise specified, the same number in different accompanying drawings denotes the same or similar elements. The embodiments described in the following examples do not denote all embodiments consistent with the disclosure. On the contrary, the embodiments are merely instances of an apparatus and a method consistent with some aspects of the disclosure as detailed in the appended claims.

It may be understood that “a plurality of” in the disclosure refers to two or above, and that other quantifiers are understood in a similar way. When describing an association relation of associated objects, “and/or” means that there may be three relations, for instance, A and/or B, which may mean that A exists alone, both A and B exist, or B exists alone. The character “/” generally means an “or” relation between two associated context objects. The singular forms such as “a”, “an”, and “the” are also intended to include the plural forms, unless otherwise clearly stated in the context.

The disclosure relates to the technical field of communication, and particularly relates to an uplink beam measurement method and apparatus thereof.

However, before the service is provided for the terminal device by the non-serving cell, an appropriate uplink beam pair between the terminal device and the non-serving cell needs to be obtained through uplink beam measurement. In the related uplink beam measurement technology, only an uplink beam between the terminal device and a serving cell can be obtained, while an appropriate uplink beam between the terminal device and the non-serving cell cannot be obtained. Thus, how to obtain the appropriate uplink beam pair between the terminal device and the non-serving cell is an urgent problem to be solved at present.

Examples of the disclosure provide a method and apparatus for measuring an uplink beam, which can be applied to the technical field of communication.

In order to facilitate understanding, terms involved in the disclosure will be firstly introduced.

### 1. Sounding Reference Signal (SRS)

In radio communication, the SRS is configured to estimate frequency domain information of an uplink channel and conduct frequency-selective scheduling, or to estimate a downlink channel and conduct downlink beamforming.

### 2. Medium Access Control (MAC) Control Element (CE)

The MAC CE is a way to exchange control information between user equipment (UE) and a network besides a radio resource control (RRC) message and a non-access stratum (NAS) message, and exchanges control information about a MAC layer.

### 3. Downlink Control Information (DCI)

The DCI is control information transmitted in a physical downlink control channel (PDCCH) and related to a physical uplink shared channel and a physical downlink shared channel (PUSCH, PDSCH). The DCI includes several related contents such as resource block (RB) allocation information and modulation modes. Only when a terminal correctly decodes the DCI, can the terminal correctly process PDSCH data or PUSCH data.

For better understanding of a method for measuring an uplink beam disclosed in the examples of the disclosure, a communication system applicable to the examples of the disclosure will be firstly described below.

With reference to FIG. 1, FIG. 1 is a schematic diagram of a framework of a communication system provided in an example of the disclosure. The communication system may include, but is not limited to, a network device and a terminal device. The number and form of the devices shown in FIG. 1 are only illustrative and do not limit the examples of the disclosure. In practical application, the communication system may include two or more network devices and two or more terminal devices. As shown in FIG. 1, the communication system includes a network device 11 and a terminal device 12.

It should be noted that technical solutions of the examples of the disclosure may be applied to various communication systems, such as a long term evolution (LTE) system, a 5th generation (5G) mobile communication system, a 5G new radio (NR) system, or other novel mobile communication systems in the future.

The network device 11 in the example of the disclosure is an entity configured to transmit or receive a signal on a network side. For instance, the network device 11 may be an evolved NodeB (eNB), a transmission reception point (TRP), a next generation NodeB (gNB) in the NR system, a base station in other future mobile communication systems, or an access node in a wireless fidelity (WiFi) system. The example of the disclosure does not limit specific technologies and specific device forms used by the network device. The network device according to the example of the disclosure may include a central unit (CU) and a distributed unit (DU). The CU may also be referred to as a control unit. With a structure of CU-DU, protocol layers of the network device, for instance, a base station, may be separated. Functions of some protocol layers are centrally controlled by the CU while functions of the other or all protocol layers are distributed in the DU, and the DU is centrally controlled by the CU.

The terminal device 12 in the example of the disclosure is an entity, for instance, a mobile phone, configured to receive or transmit a signal on a user side. The terminal device may also be referred to as a terminal, user equipment (UE), a mobile station (MS), a mobile terminal (MT), etc. The terminal device may be a vehicle having a communication function, an intelligent vehicle, a mobile phone, a wearable device, Pad, a computer having a radio transceiving function, a virtual reality (VR) terminal device, an augmented reality (AR) terminal device, a radio terminal device in industrial control, a radio terminal device in self-driving, a radio terminal device in remote medical surgery, a radio terminal device in smart grid, a radio terminal device in transportation safety, a radio terminal device in smart city, a radio terminal device in smart home, etc. The example of the disclosure does not limit specific technologies and specific device forms used by the terminal device.

It may be understood that the communication system according to the example of the disclosure is intended to describe the technical solution of the example of the disclosure more clearly, instead of limiting the technical solution according to the example of the disclosure. Those of ordinary skill in the art may know that the technical solution according to the example of the disclosure is also applicable to similar technical problems with evolution of a system structure and emergence of new business scenarios.

The method and apparatus for measuring an uplink beam according to the disclosure will be described in detail with reference to the accompanying drawings below.

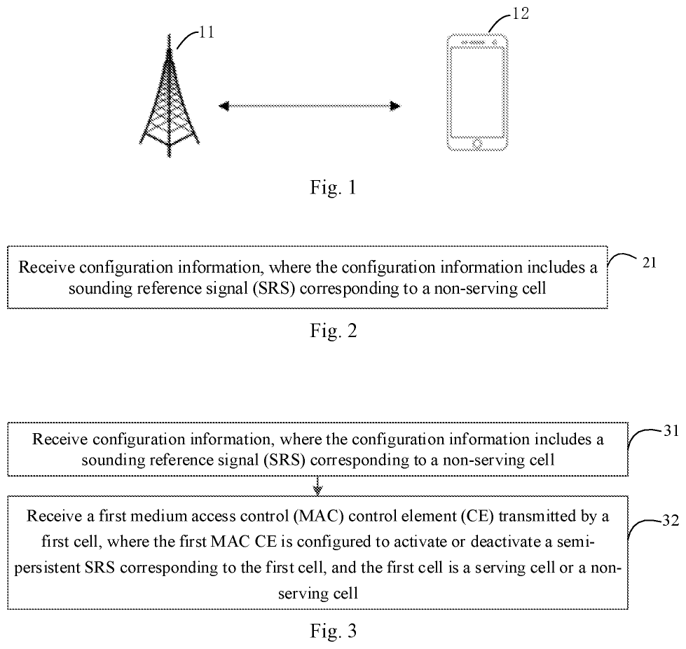

With reference to FIG. 2, FIG. 2 is a schematic flow diagram of a method for measuring an uplink beam provided in an example of the disclosure. The method is performed by a terminal device. As shown in FIG. 2, the method may include, but is not limited to, the following step:

Step 21, configuration information is received, where the configuration information includes a sounding reference signal (SRS) corresponding to a non-serving cell.

It should be noted that a network device may generally configure an SRS resource corresponding to a serving cell for the terminal device through radio resource control (RRC) signaling in the related art, such that the terminal device may transmit the SRS on a configured time-frequency domain resource. Different SRSs correspond to different transmitted beams. After receiving the SRS, the serving cell may determine an optimal transmitted beam according to reception power. In the related art, only an uplink beam between the serving cell and the terminal device can be determined, and an appropriate uplink beam between the terminal device and the non-serving cell cannot be determined. In the disclosure, the network device may not only configure the SRS resource corresponding to the serving cell for the terminal device, but also configure an SRS resource corresponding to the non-serving cell for the terminal device. In this way, the terminal device may transmit the SRS to the non-serving cell based on the SRS resource corresponding to the non-serving cell, such that the non-serving cell determines the optimal transmitted beam between the non-serving cell and the terminal device according to measured reception power of each SRS, and further service is provided for the terminal device.

Optionally, the configuration information may further include: a path loss reference signal (PL RS) corresponding to the non-serving cell, a spatialRelationInfo corresponding to the non-serving cell, etc., which is not limited by the disclosure. In this way, after receiving the configuration information, the terminal device may determine transmission power of the SRS according to the PL RS corresponding to the non-serving cell, and determine a transmitted beam corresponding to the SRS according to the spatialRelationInfo. Further, the SRS is transmitted to the non-serving cell based on the determined transmission power and transmitted beam.

Optionally, the number of non-serving cells may be one or more, and for instance, 1, 3, 5, etc., which is not limited by the disclosure.

Optionally, the SRS corresponding to the non-serving cell may be a cyclicity SRS, a semi-persistent SRS, or an aperiodic SRS, which is not limited by the disclosure.

Through implementation of the example of the disclosure, the terminal device receives the configuration information including the sounding reference signal (SRS) corresponding to the non-serving cell, and then may transmit the SRS to the non-serving cell, such that the non-serving cell determines the optimal transmitted beam of the terminal device according to the measured reception power. In this way, uplink beam measurement between the terminal device and the non-serving cell is achieved, and a basis is provided for the non-serving cell to provide service for the terminal device.

With reference to FIG. 3, FIG. 3 is a schematic flow diagram of a method for measuring an uplink beam provided in an example of the disclosure. The method is performed by a terminal device. As shown in FIG. 3, the method may include, but is not limited to, the following steps:

Step 31, configuration information is received, where the configuration information includes a sounding reference signal (SRS) corresponding to a non-serving cell.

Reference may be made to detailed description in other examples of the disclosure for a specific implementation form of step 31, which will not be described in detail here.

Step 32, a first medium access control (MAC) control element (CE) transmitted by a first cell is received. The first MAC CE is configured to activate or deactivate a semi-persistent SRS corresponding to the first cell. The first cell is a serving cell or a non-serving cell.

It may be understood that for the semi-persistent SRS, the terminal device may transmit the SRS to the serving cell or the non-serving cell based on a time-frequency domain resource corresponding to an activated semi-persistent SRS only after the semi-persistent SRS is activated according to a MAC CE.

For instance, if a cell providing service for the terminal device changes from cell A to cell B, the terminal device has to deactivate a semi-persistent SRS corresponding to the cell A and activate a semi-persistent SRS corresponding to the cell B. In the example, the terminal device may deactivate the semi-persistent SRS corresponding to the cell A according to a MAC CE transmitted by the cell A, and activate the semi-persistent SRS corresponding to the cell B according to a MAC CE transmitted by the cell B.

Through implementation of the example of the disclosure, the terminal device receives the SRS corresponding to the non-serving cell, and then activates or deactivates the semi-persistent SRS corresponding to the serving cell or the non-serving cell according to the received MAC CE transmitted by the first cell. In this way, after activating the semi-persistent SRS, the terminal device may obtain an appropriate uplink beam pair between the terminal device and the non-serving cell, and further the non-serving cell may provide service for the terminal device.

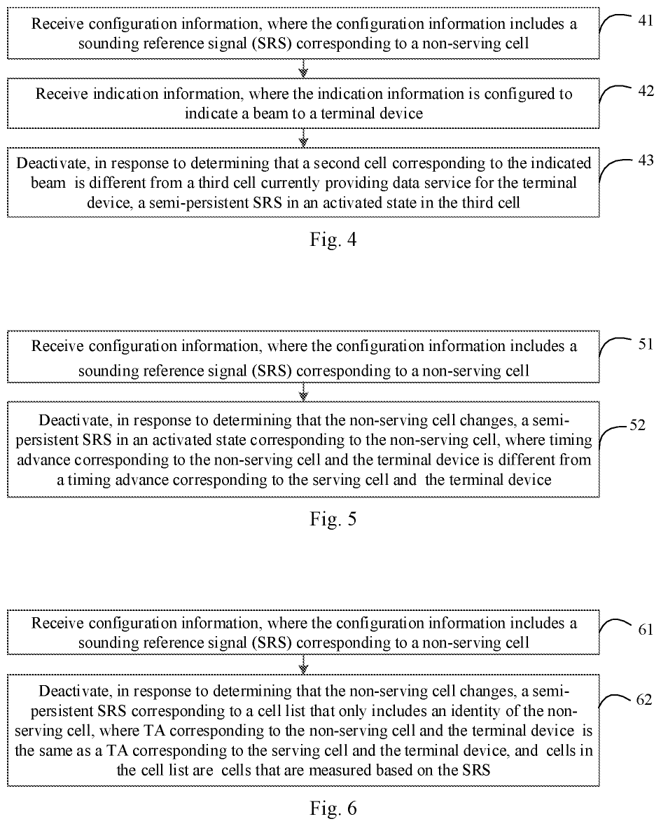

With reference to FIG. 4, FIG. 4 is a schematic flow diagram of a method for measuring an uplink beam provided in an example of the disclosure. The method is performed by a terminal device. As shown in FIG. 4, the method may include, but is not limited to, the following steps:

Step 41, configuration information is received, where the configuration information includes a sounding reference signal (SRS) corresponding to a non-serving cell.

Reference may be made to detailed description in other examples of the disclosure for a specific implementation form of step 41, which will not be described in detail here.

Step 42, indication information is received, where the indication information is configured to indicate a beam to the terminal device.

Optionally, a network device may transmit the indication information to the terminal device by means of a MAC CE. Alternatively, a network device may transmit the indication information to the terminal device through DCI.

Step 43, in response to determining that a second cell corresponding to the beam indicated is different from a third cell currently providing data service for the terminal device, a semi-persistent SRS in an activated state in the third cell is deactivated.

It should be noted that a correspondence between beams and cells may be pre-configured.

It may be understood that the second cell corresponding to the beam indicated may be a cell that is about to provide service for the terminal device, such that after the network device indicates the beam to the terminal device, in response to determining that the second cell corresponding to the beam indicated is different from the third cell currently providing data service for the terminal device, the terminal device may deactivate the semi-persistent SRS in the activated state in the third cell. In this way, the terminal device may transmit the SRS to the second cell according to the beam indicated.

Through implementation of the example of the disclosure, in an inter-cell mobility scene, the terminal device first receives the SRS corresponding to the non-serving cell, then receives the indication information indicating the beam to the terminal device, and finally deactivates, in response to determining that the second cell corresponding to the beam indicated is different from the third cell currently providing data service for the terminal device, the semi-persistent SRS in the activated state in the third cell. In this way, the terminal device may transmit the SRS to the corresponding second cell based on the beam indicated, and the second cell provides service for the terminal device.

With reference to FIG. 5, FIG. 5 is a schematic flow diagram of a method for measuring an uplink beam provided in an example of the disclosure. The method is performed by a terminal device. As shown in FIG. 5, the method may include, but is not limited to, the following steps:

Step 51, configuration information is received, where the configuration information includes a sounding reference signal (SRS) corresponding to a non-serving cell.

Reference may be made to detailed description in other examples of the disclosure for a specific implementation form of step 51, which will not be described in detail here.

Step 52, in response to determining that the non-serving cell changes, a semi-persistent SRS in an activated state corresponding to the non-serving cell is deactivated. A timing advance corresponding to the non-serving cell and the terminal device is different from a timing advance (TA) corresponding to the serving cell and the terminal device.

It may be understood that when a TA corresponding to the non-serving cell and the terminal device is different from a TA corresponding to the serving cell and the terminal device, the non-serving cell and the serving cell manage corresponding SRSs respectively. In this case, with movement of the terminal device, the non-serving cell corresponding to the terminal device may change from non-serving cell A to non-serving cell B. In this case, the terminal device does not have to transmit an SRS to the non-serving cell A, such that the terminal device has to deactivate a semi-persistent SRS in an activated state corresponding to the non-serving cell A.

Optionally, the terminal device may determine that the non-serving cell changes according to high level signaling transmitted by a network device.

Through implementation of the example of the disclosure, in an inter-cell multi-transmission reception point (TRP) scene, the terminal device first receives the SRS corresponding to the non-serving cell, and then deactivates the semi-persistent SRS in the activated state corresponding to the non-serving cell in response to determining that the non-serving cell changes and a timing advance corresponding to the non-serving cell and the terminal device is different from a timing advance corresponding to the serving cell and the terminal device. In this way, uplink beam measurement between the terminal device and the non-serving cell is achieved, and the semi-persistent SRS is reliably deactivated when the non-serving cell changes, which ensures that the non-serving cell may provide reliable service for the terminal device and resource waste is avoided.

With reference to FIG. 6, FIG. 6 is a schematic flow diagram of a method for measuring an uplink beam provided in an example of the disclosure. The method is performed by a terminal device. As shown in FIG. 6, the method may include, but is not limited to, the following steps:

Step 61, configuration information is received, where the configuration information includes a sounding reference signal (SRS) corresponding to a non-serving cell.

Reference may be made to detailed description in other examples of the disclosure for a specific implementation form of step 61, which will not be described in detail here.

Step 62, in response to determining that the non-serving cell changes, a semi-persistent SRS corresponding to a cell list that only includes an identity of the non-serving cell is deactivated. A timing advance corresponding to the non-serving cell and the terminal device is the same as a timing advance corresponding to the serving cell and the terminal device. Cells in the cell list are cells that are measured based on the SRS.

It should be noted that in response to determining that the TAs corresponding to the non-serving cell and the serving cell are the same as the TA corresponding to the terminal device, the non-serving cell and the serving cell may be simultaneously measured based on the same SRS. If the semi-persistent SRS is directly deactivated, the SRS corresponding to the serving cell may be unusable. Thus, the terminal device may record a cell list that is measured based on each SRS, and then determine whether to deactivate the semi-persistent SRS based on cell situations included in the cell list corresponding to the semi-persistent SRS in response to determining that the non-serving cell changes.

For instance, when the terminal device changes from non-serving cell A to non-serving cell B during movement, a cell list corresponding to a semi-persistent SRS #1 only includes an identity of the non-serving cell A, and a cell list corresponding to a semi-persistent SRS #2 includes the non-serving cell A and the non-serving cell B, only the semi-persistent SRS #1 may be deactivated.

Optionally, the terminal device may determine a cell list corresponding to semi-persistent SRS according to a first MAC CE received.

Optionally, the semi-persistent SRS in the activated state corresponding to the non-serving cell may be deactivated in response to determining that the non-serving cell changes and a timing advance corresponding to the non-serving cell and the terminal device is the same as a timing advance corresponding to the serving cell and the terminal device.

Through implementation of the example of the disclosure, in an inter-cell multi-transmission reception point (TRP) scene, the terminal device first receives the SRS corresponding to the non-serving cell, and then deactivates the semi-persistent SRS corresponding to a cell list that only includes the identity of the non-serving cell in response to determining that the non-serving cell changes and a timing advance corresponding to the non-serving cell and the terminal device is the same as a timing advance corresponding to the serving cell and the terminal device. In this way, uplink beam measurement between the terminal device and the non-serving cell is achieved, and the semi-persistent SRS is reliably deactivated when the non-serving cell changes, which ensures that the non-serving cell may provide reliable service for the terminal device and resource waste is avoided.

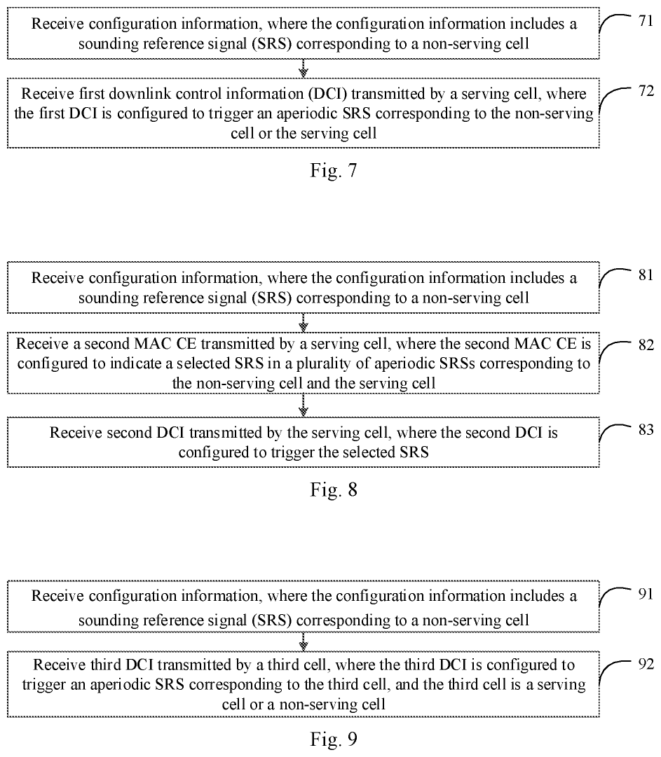

With reference to FIG. 7, FIG. 7 is a schematic flow diagram of a method for measuring an uplink beam provided in an example of the disclosure. The method is performed by a terminal device. As shown in FIG. 7, the method may include, but is not limited to, the following steps:

Step 71, configuration information is received, where the configuration information includes a sounding reference signal (SRS) corresponding to a non-serving cell.

Reference may be made to detailed description in other examples of the disclosure for a specific implementation form of step 71, which will not be described in detail here.

Step 72, first downlink control information (DCI) transmitted by a serving cell is received, where the first DCI is configured to trigger an aperiodic SRS corresponding to the non-serving cell or the serving cell.

Optionally, a network device may add N bits to an SRS request field in DCI of the serving cell, so as to instruct the terminal device to trigger the aperiodic SRS corresponding to the non-serving cell and/or the serving cell. N may be 2, 4, etc., which is not limited by the disclosure.

It may be understood that after the aperiodic SRS corresponding to the non-serving cell and the serving cell is triggered, the terminal device may transmit the SRS according to the configuration information of the triggered SRS, such that the serving cell and/or the non-serving cell may conduct uplink beam measurement.

Through implementation of the example of the disclosure, the network device configures an SRS resource corresponding to the non-serving cell for the terminal device, and then may transmit the first DCI to the terminal device by means of the serving cell, so as to trigger the aperiodic SRSs corresponding to the non-serving cell and the serving cell. In this way, the terminal device may transmit the SRS with the triggered SRS resource, such that uplink beam measurement is completed. In this way, the DCI transmitted by the serving cell may trigger the aperiodic SRSs corresponding to the serving cell and the non-serving cell. Accordingly, uplink beam measurement between the terminal device and the non-serving cell is achieved, and a basis is provided for the non-serving cell to provide service for the terminal device.

With reference to FIG. 8, FIG. 8 is a schematic flow diagram of a method for measuring an uplink beam provided in an example of the disclosure. The method is performed by a terminal device. As shown in FIG. 8, the method may include, but is not limited to, the following steps:

Step 81, configuration information is received, where the configuration information includes a sounding reference signal (SRS) corresponding to a non-serving cell.

Reference may be made to detailed description in other examples of the disclosure for a specific implementation form of step 81, which will not be described in detail here.

Step 82, a second MAC CE transmitted by a serving cell is received, where the second MAC CE is configured to indicate a selected SRS in a plurality of aperiodic SRSs corresponding to the non-serving cell and the serving cell.

Optionally, a network device may indicate the selected SRS in the plurality of aperiodic SRSs corresponding to the non-serving cell and the serving cell through a plurality of bits in the MAC CE. For instance, if the non-serving cell and the serving cell correspond to N aperiodic SRSs, the MAC CE may at least include selection state identity bits T0-TN corresponding to all the SRSs. Ti=1 indicates that a corresponding ith SRS resource set is selected. Ti=0 indicates that a corresponding ith SRS resource set is not selected. For instance, T0=1 indicates that a first SRS resource set is selected.

For instance, if the configuration information received by the terminal device includes 8 SRSs corresponding to the non-serving cell and the serving cell, the second MAC CE may include 8 selection state identity bits. Then, the serving cell may instruct the terminal device to select 2, 4 or 5 SRSs from the 8 SRSs by transmitting the second MAC CE to the terminal device.

Step 83, second DCI transmitted by the serving cell is received, where the second DCI is configured to trigger the selected SRS.

It may be understood that for the aperiodic SRS, the DCI transmitted by the network device has to be received, and after the aperiodic SRS is triggered, the SRS may be transmitted to the non-serving cell and the serving cell based on the triggered SRS.

In the disclosure, the second MAC CE may be transmitted to the terminal device by means of the serving cell, such that some SRSs are selected from the plurality of aperiodic SRSs. Then, the second DCI may be transmitted to the terminal device by means of the serving cell, such that some SRSs in the selected SRSs are triggered. Then, the terminal device may transmit the SRS to the non-serving cell or the serving cell based on the triggered SRS resource, such that uplink beam measurement is completed.

For instance, the configuration information received by the terminal device may include 8 SRSs corresponding to the non-serving cell and the serving cell. Then, the terminal device receives the second MAC CE transmitted by the network device, selects 4 SRSs from the 8 SRSs according to an instruction of the second MAC CE, and finally receives the second DCI transmitted by the network device, such that the selected SRS is triggered.

Through implementation of the example of the disclosure, the terminal device receives the SRS corresponding to the non-serving cell, and then may select some SRSs from the plurality of aperiodic SRSs according to the received second MAC CE transmitted by the serving cell. According to the received second DCI transmitted by the serving cell, an SRS to be triggered is determined, and then uplink beam measurement may be completed based on the triggered SRS. In this way, some SRSs of the plurality of aperiodic SRSs corresponding to the non-serving cell and the serving cell may be triggered through the second MAC CE and the second DCI transmitted by the serving cell, such that uplink beam measurement between the terminal device and the non-serving cell is achieved, and a basis is provided for the non-serving cell to provide service for the terminal device.

With reference to FIG. 9, FIG. 9 is a schematic flow diagram of a method for measuring an uplink beam provided in an example of the disclosure. The method is performed by a terminal device. As shown in FIG. 9, the method may include, but is not limited to, the following steps:

Step 91, configuration information is received, where the configuration information includes a sounding reference signal (SRS) corresponding to a non-serving cell.

Reference may be made to detailed description in other examples of the disclosure for a specific implementation form of step 91, which will not be described in detail here.

Step 92, third DCI transmitted by a third cell is received, where the third DCI is configured to trigger an aperiodic SRS corresponding to the third cell. The third cell is a serving cell or a non-serving cell.

It may be understood that for the aperiodic SRS, the terminal device has to trigger the aperiodic SRS according to the received DCI, the SRS may be transmitted to the non-serving cell and the serving cell based on the triggered SRS.

In the disclosure, the non-serving cell and the serving cell may indicate the triggered aperiodic SRS to the terminal device through respective DCI, and then the terminal device may indicate the triggered SRS according to the serving cell so as to complete uplink beam measurement of the serving cell, and indicate the triggered SRS based on the non-serving cell so as to complete uplink beam measurement of the non-serving cell.

For instance, the serving cell indicates that a corresponding aperiodic SRS resource set set #1 is triggered by transmitting the third DCI to the terminal device and the non-serving cell indicates that a corresponding aperiodic SRS resource set set #5 is triggered by transmitting the third DCI to the terminal device, the terminal device may transmit the SRS to the serving cell based on a resource corresponding to the SRS set #1, so as to complete uplink beam measurement corresponding to the serving cell, and transmit the SRS to the non-serving cell based on a resource corresponding to the SRS set #5, so as to complete uplink beam measurement corresponding to the non-serving cell.

Through implementation of the example of the disclosure, the terminal device receives the configuration information configured to configure the SRS corresponding to the non-serving cell, and then may trigger the aperiodic SRS corresponding to the third cell according to the received third DCI transmitted by the third cell. In this way, the serving cell and the non-serving cell may trigger corresponding aperiodic SRSs respectively. Accordingly, uplink beam measurement between the terminal device and the non-serving cell is achieved, and a basis is provided for the non-serving cell to provide service for the terminal device.

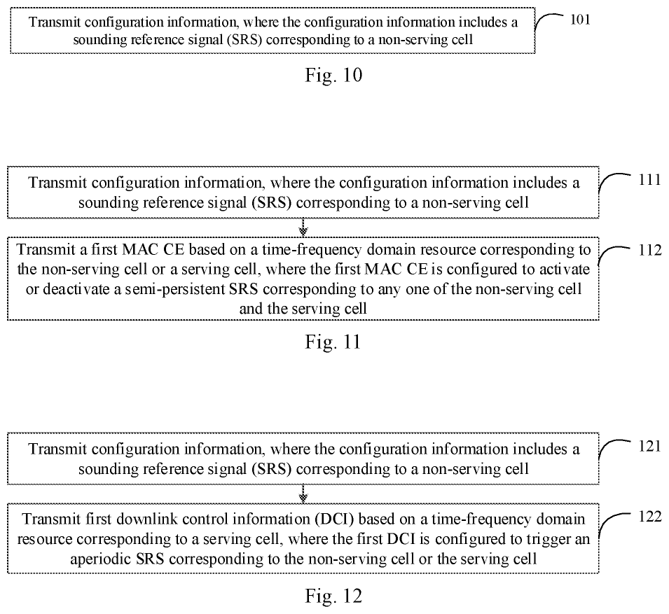

With reference to FIG. 10, FIG. 10 is a schematic flow diagram of a method for measuring an uplink beam provided in an example of the disclosure. The method is performed by a network device. As shown in FIG. 10, the method may include, but is not limited to, the following step:

Step 101, configuration information is transmitted, where the configuration information includes a sounding reference signal (SRS) corresponding to a non-serving cell.

It should be noted that a network device may generally configure an SRS resource corresponding to a serving cell for the terminal device through radio resource control (RRC) signaling in the related art, such that the terminal device may transmit the SRS on a configured time-frequency domain resource. Different SRSs correspond to different transmitted beams. After receiving the SRS, the serving cell may determine an optimal transmitted beam according to reception power. In the related art, only an uplink beam between the serving cell and the terminal device can be determined, and an appropriate uplink beam between the terminal device and the non-serving cell cannot be determined. In the disclosure, the network device may not only configure the SRS resource corresponding to the serving cell for the terminal device, but also configure an SRS resource corresponding to the non-serving cell for the terminal device. In this way, the terminal device may transmit the SRS to the non-serving cell based on the SRS resource corresponding to the non-serving cell, such that the non-serving cell determines the optimal transmitted beam between the non-serving cell and the terminal device according to measured reception power of each SRS, and further service is provided for the terminal device.

Optionally, the configuration information may further include: a path loss reference signal (PL RS) corresponding to the non-serving cell, a spatialRelationInfo corresponding to the non-serving cell, etc., which is not limited by the disclosure. In this way, after receiving the configuration information, the terminal device may determine transmission power of the SRS according to the PL RS corresponding to the non-serving cell, and determine a transmitted beam corresponding to the SRS according to the spatialRelationInfo. Further, the SRS is transmitted to the non-serving cell based on the determined transmission power and transmitted beam.

Optionally, the number of non-serving cells may be one or more, and for instance, 1, 3, 5, etc., which is not limited by the disclosure.

Optionally, the SRS corresponding to the non-serving cell may be a cyclicity SRS, a semi-persistent SRS, or an aperiodic SRS, which is not limited by the disclosure.

Through implementation of the example of the disclosure, the network device transmits the configuration information including the sounding reference signal (SRS) corresponding to the non-serving cell to the terminal device, and the terminal device transmits the SRS to the non-serving cell, such that the non-serving cell determines the optimal transmitted beam of the terminal device according to the measured reception power. In this way, uplink beam measurement between the terminal device and the non-serving cell is achieved, and a basis is provided for the non-serving cell to provide service for the terminal device.

With reference to FIG. 11, FIG. 11 is a schematic flow diagram of a method for measuring an uplink beam provided in an example of the disclosure. The method is performed by a network device. As shown in FIG. 11, the method may include, but is not limited to, the following steps:

Step 111, configuration information is transmitted, where the configuration information includes a sounding reference signal (SRS) corresponding to a non-serving cell.

Reference may be made to detailed description in other examples of the disclosure for a specific implementation form of step 111, which will not be described in detail here.

Step 112, a first medium access control (MAC) control element (CE) is transmitted based on a time-frequency domain resource corresponding to the non-serving cell or a serving cell. The first MAC CE is configured to activate or deactivate a semi-persistent SRS corresponding to any one of the non-serving cell and the serving cell.

It may be understood that for the semi-persistent SRS, the terminal device may transmit the SRS to the serving cell or the non-serving cell based on a time-frequency domain resource corresponding to an activated semi-persistent SRS only after the semi-persistent SRS is activated according to a MAC CE transmitted by the network device.

For instance, if a cell providing service for the terminal device changes from cell A to cell B, the network device may transmit the MAC CE to the terminal device based on a time-frequency domain resource corresponding to the cell A, so as to deactivate the semi-persistent SRS corresponding to the cell A; and transmit the MAC CE to the terminal device based on a time-frequency domain resource corresponding to the cell B, so as to activate the semi-persistent SRS corresponding to the cell B. In this way, the cell B may provide service for the terminal device.

Through implementation of the example of the disclosure, the network device transmits the SRS corresponding to the non-serving cell to the terminal device, then transmits the first MAC CE to the terminal device based on the time-frequency domain resource corresponding to the non-serving cell or the serving cell, and activates or deactivates the semi-persistent SRS corresponding to the serving cell or the non-serving cell. In this way, after activating the semi-persistent SRS corresponding to the non-serving cell by means of the MAC CE, the network device may obtain an appropriate uplink beam pair between the terminal device and the non-serving cell, and further the non-serving cell may provide service for the terminal device.

With reference to FIG. 12, FIG. 12 is a schematic flow diagram of a method for measuring an uplink beam provided in an example of the disclosure. The method is performed by a network device. As shown in FIG. 12, the method may include, but is not limited to, the following steps:

Step 121, configuration information is transmitted, where the configuration information includes a sounding reference signal (SRS) corresponding to a non-serving cell.

Reference may be made to detailed description in other examples of the disclosure for a specific implementation form of step 121, which will not be described in detail here.

Step 122, first downlink control information (DCI) is transmitted based on a time-frequency domain resource corresponding to a serving cell, where the first DCI is configured to trigger an aperiodic SRS corresponding to the non-serving cell or the serving cell.

Optionally, the network device may add N bits to an SRS request field in the first DCI, so as to instruct the terminal device to trigger the aperiodic SRS corresponding to the non-serving cell and/or the serving cell. N may be 2, 4, etc., which is not limited by the disclosure.

It may be understood that after the aperiodic SRS corresponding to the non-serving cell and the serving cell is triggered, the terminal device may transmit the SRS with the configuration information of the triggered SRS, such that the serving cell and/or the non-serving cell may conduct uplink beam measurement.

Through implementation of the example of the disclosure, the network device configures an SRS resource corresponding to the non-serving cell for the terminal device, and then may transmit the first DCI to the terminal device by means of the serving cell, so as to trigger the aperiodic SRSs corresponding to the non-serving cell and the serving cell. In this way, the terminal device may transmit the SRS with the triggered SRS resource, such that uplink beam measurement is completed. In this way, the DCI transmitted by the serving cell may trigger the aperiodic SRSs corresponding to the serving cell and the non-serving cell. Accordingly, uplink beam measurement between the terminal device and the non-serving cell is achieved, and a basis is provided for the non-serving cell to provide service for the terminal device.

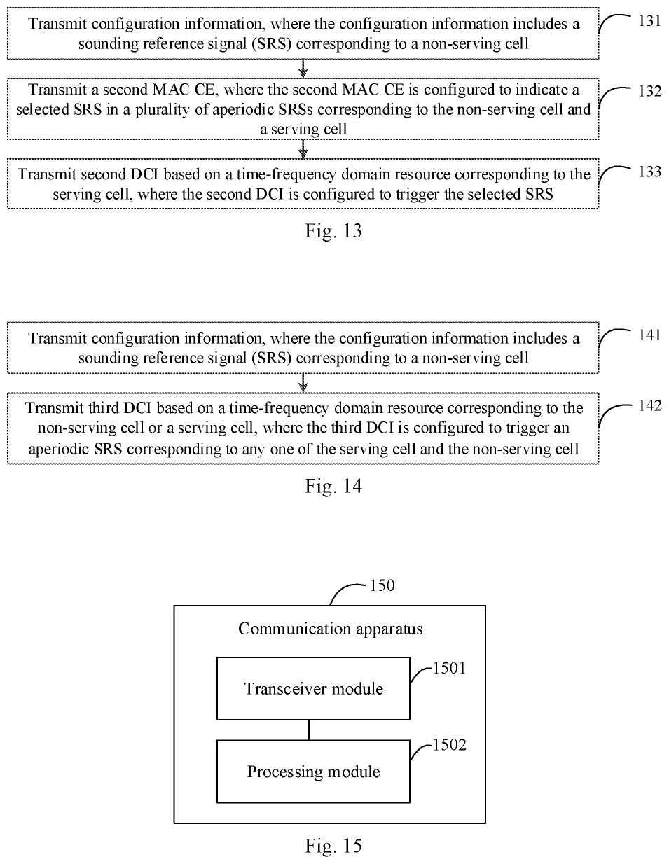

With reference to FIG. 13, FIG. 13 is a schematic flow diagram of a method for measuring an uplink beam provided in an example of the disclosure. The method is performed by a network device. As shown in FIG. 13, the method may include, but is not limited to, the following steps:

Step 131, configuration information is transmitted, where the configuration information includes a sounding reference signal (SRS) corresponding to a non-serving cell.

Reference may be made to detailed description in other examples of the disclosure for a specific implementation form of step 131, which will not be described in detail here.

Step 132, a second MAC CE is transmitted, where the second MAC CE is configured to indicate a selected SRS in a plurality of aperiodic SRSs corresponding to the non-serving cell and a serving cell.

Optionally, the network device may indicate the selected SRS in the plurality of aperiodic SRSs corresponding to the non-serving cell and the serving cell through a plurality of bits in the MAC CE. For instance, if the non-serving cell and the serving cell correspond to N aperiodic SRSs, the MAC CE may at least include selection state identity bits T0-TN corresponding to all the SRSs. Ti=1 indicates that a corresponding ith SRS resource set is selected. Ti=0 indicates that a corresponding ith SRS resource set is not selected. For instance, T0=1 indicates that a first SRS resource set is selected.

Step 133, second DCI is transmitted based on a time-frequency domain resource corresponding to the serving cell, where the second DCI is configured to trigger the selected SRS.

It may be understood that for the aperiodic SRS, the network device has to transmit the DCI to the terminal device, and after the selected aperiodic SRS is triggered, the terminal device may transmit the SRS to the non-serving cell and the serving cell based on the triggered SRS.

In the disclosure, the second MAC CE may be transmitted to the terminal device by means of the serving cell, such that some SRSs are selected from the plurality of aperiodic SRSs. Then, the second DCI may be transmitted to the terminal device by means of the serving cell, such that some SRSs in the selected SRSs are triggered. Then, the terminal device may transmit the SRS to the non-serving cell or the serving cell based on the triggered SRS resource, such that uplink beam measurement is completed.

For instance, the configuration information transmitted by the network device may include 8 SRSs corresponding to the non-serving cell and the serving cell. Then, the network device transmits the second MAC CE to the terminal device, so as to instruct the terminal device to select 4 SRSs from the 8 SRSs, and finally transmits the second DCI to the terminal device, so as to trigger the selected SRS.

Through implementation of the example of the disclosure, the network device transmits the SRS corresponding to the non-serving cell to the terminal device, then transmits the second MAC CE to the terminal device, so as to indicate the selected SRS in the plurality of aperiodic SRSs corresponding to the non-serving cell and the serving cell, and finally transmits the second DCI to the terminal device by means of the serving cell, so as to trigger the selected SRS. In this way, some SRSs of the plurality of aperiodic SRSs corresponding to the non-serving cell and the serving cell may be triggered through the second MAC CE and the second DCI transmitted by the serving cell, such that uplink beam measurement between the terminal device and the non-serving cell is achieved, and a basis is provided for the non-serving cell to provide service for the terminal device.

With reference to FIG. 14, FIG. 14 is a schematic flow diagram of a method for measuring an uplink beam provided in an example of the disclosure. The method is performed by a network device. As shown in FIG. 14, the method may include, but is not limited to, the following steps:

Step 141, configuration information is transmitted, where the configuration information includes a sounding reference signal (SRS) corresponding to a non-serving cell.

Reference may be made to detailed description in other examples of the disclosure for a specific implementation form of step 141, which will not be described in detail here.

Step 142, third DCI is transmitted based on a time-frequency domain resource corresponding to the non-serving cell or a serving cell, where the third DCI is configured to trigger an aperiodic SRS corresponding to any one of the serving cell and the non-serving cell.

It may be understood that for the aperiodic SRS, the network device has to transmit DCI to a terminal device, so as to trigger the aperiodic SRS corresponding to the non-serving cell or the serving cell, and then may transmit the SRS to the non-serving cell and the serving cell based on a triggered SRS resource.

In the disclosure, the non-serving cell and the serving cell may indicate the triggered aperiodic SRS to the terminal device through respective DCI, and then the terminal device may indicate the triggered SRS according to the serving cell so as to complete uplink beam measurement of the serving cell, and indicate the triggered SRS based on the non-serving cell so as to complete uplink beam measurement of the non-serving cell.

For instance, if the serving cell indicates that a corresponding aperiodic SRS resource set set #1 is triggered by transmitting the third DCI to the terminal device and the non-serving cell indicates that a corresponding aperiodic SRS resource set set #5 is triggered by transmitting the third DCI to the terminal device, the terminal device may transmit the SRS to the serving cell based on a resource corresponding to the SRS set #1, so as to complete uplink beam measurement corresponding to the serving cell, and transmit the SRS to the non-serving cell based on a resource corresponding to the SRS set #5, so as to complete uplink beam measurement corresponding to the non-serving cell.

Through implementation of the example of the disclosure, the network device transmits the SRS corresponding to the non-serving cell to the terminal device, and then transmits the third DCI based on the time-frequency domain resource corresponding to the non-serving cell or the serving cell, so as to trigger the aperiodic SRS corresponding to any one of the serving cell and the non-serving cell. In this way, the serving cell and the non-serving cell may trigger corresponding aperiodic SRSs respectively. Accordingly, uplink beam measurement between the terminal device and the non-serving cell is achieved, and a basis is provided for the non-serving cell to provide service for the terminal device.

In the example according to the disclosure, the method according to the example of the disclosure is introduced from aspects of the network device and the terminal device separately. In order to achieve functions of the method according to the example of the disclosure, the network device and the terminal device may include hardware structures and software modules. The above functions are achieved in the form of the hardware structure, the software module, or a combination of the hardware structure and the software module. One of the above functions may be implemented by a hardware structure, a software module, or a combination of a hardware structure and a software module.

FIG. 15 is a schematic structural diagram of a communication apparatus 150 according to an example of the disclosure. The communication apparatus 150 shown in FIG. 15 may include a processing module 1501 and a transceiver module 1502.

The transceiver module 1502 may include a transmission module and/or a reception module. The transmission module is configured to achieve a transmission function. The reception module is configured to achieve a reception function. The transceiver module 1502 may achieve the transmission function and/or the reception function.

It may be understood that the communication apparatus 150 may be a terminal device, or an apparatus in a terminal device, or an apparatus capable of cooperating with a terminal device.

The communication apparatus 150 is configured on a terminal device side. The apparatus includes:
the transceiver module 1502 configured to receive configuration information, where the configuration information includes a sounding reference signal (SRS) corresponding to a non-serving cell.

Optionally, the configuration information further includes: a path loss reference signal corresponding to the non-serving cell and a spatialRelationInfo corresponding to the non-serving cell.

Optionally, the transceiver module 1502 is further specifically configured to:
receive a first medium access control (MAC) control element (CE) transmitted by a first cell. The first MAC CE is configured to activate or deactivate a semi-persistent SRS corresponding to the first cell. The first cell is a serving cell or a non-serving cell.

Optionally, further including:
the transceiver module 1502 is further configured to receive indication information, where the indication information is configured to indicate a beam to the terminal device; and
the processing module 1501 is configured to deactivate, in response to determining that a second cell corresponding to the beam indicated is different from a third cell currently providing data service for the terminal device, a semi-persistent SRS in an activated state in the third cell.

Optionally, the processing module 1501 is further specifically configured to:
deactivate, in response to determining that the non-serving cell changes, a semi-persistent SRS in an activated state corresponding to the non-serving cell, where a timing advance corresponding to the non-serving cell and the terminal device is different from a timing advance corresponding to the serving cell and the terminal device.

Optionally, the processing module 1501 is further specifically configured to:
deactivate, in response to determining that the non-serving cell changes, a semi-persistent SRS in an activated state corresponding to the non-serving cell; and alternatively,
deactivate, in response to determining that the non-serving cell changes, a semi-persistent SRS corresponding to a cell list that only includes an identity of the non-serving cell.

A timing advance corresponding to the non-serving cell and the terminal device is the same as a timing advance corresponding to the serving cell and the terminal device. Cells in the cell list are cells that are measured based on the SRS.

Optionally, the processing module 1501 is further specifically configured to:

Determine a cell list corresponding to semi-persistent SRS according to a first MAC CE received.

Optionally, the transceiver module 1502 is further specifically configured to:
receive first downlink control information (DCI) transmitted by a serving cell. The first DCI is configured to trigger an aperiodic SRS corresponding to the non-serving cell or the serving cell.

Optionally, the transceiver module 1502 is further specifically configured to:
receive a second MAC CE, where the second MAC CE is configured to indicate a selected SRS in a plurality of aperiodic SRSs corresponding to the non-serving cell and the serving cell; and
receive second DCI transmitted by the serving cell, where the second DCI is configured to trigger the selected SRS.

Optionally, the transceiver module 1502 is further specifically configured to:
receive third DCI transmitted by a third cell. The third DCI is configured to trigger an aperiodic SRS corresponding to the third cell. The third cell is a serving cell or a non-serving cell.

According to the communication apparatus of the disclosure, the terminal device receives the configuration information including the sounding reference signal (SRS) corresponding to the non-serving cell, and then may transmit the SRS to the non-serving cell, such that the non-serving cell determines an optimal transmitted beam of the terminal device according to measured reception power. In this way, uplink beam measurement between the terminal device and the non-serving cell is achieved, and a basis is provided for the non-serving cell to provide service for the terminal device.

It may be understood that the communication apparatus 150 may be a network device, or an apparatus in a network device, or an apparatus capable of cooperating with a network device.

The communication apparatus 150 is configured on a network device side. The apparatus includes:
a transceiver module 1502 configured to transmit configuration information, where the configuration information includes a sounding reference signal (SRS) corresponding to a non-serving cell.

Optionally, the configuration information further includes: a path loss reference signal corresponding to the non-serving cell and a spatialRelationInfo corresponding to the non-serving cell.

Optionally, the transceiver module 1502 is further specifically configured to:
transmit a first medium access control (MAC) control element (CE) based on a time-frequency domain resource corresponding to the non-serving cell or a serving cell. The first MAC CE is configured to activate or deactivate a semi-persistent SRS corresponding to any one of the non-serving cell and the serving cell.

Optionally, the transceiver module 1502 is further specifically configured to:
transmit first downlink control information (DCI) based on a time-frequency domain resource corresponding to the serving cell. The first DCI is configured to trigger an aperiodic SRS corresponding to the non-serving cell or the serving cell.

Optionally, the transceiver module 1502 is further specifically configured to:
transmit a second MAC CE, where the second MAC CE is configured to indicate a selected SRS in a plurality of aperiodic SRSs corresponding to the non-serving cell and the serving cell;
transmit second DCI based on a time-frequency domain resource corresponding to the serving cell, where the second DCI is configured to trigger the selected SRS.

Optionally, the transceiver module 1502 is further specifically configured to:
transmit third DCI based on the time-frequency domain resource corresponding to the non-serving cell or the serving cell. The third DCI is configured to trigger an aperiodic SRS corresponding to any one of the serving cell and the non-serving cell.

According to the communication apparatus of the disclosure, the network device transmits the configuration information including the sounding reference signal (SRS) corresponding to the non-serving cell to the terminal device, and the terminal device transmits the SRS to the non-serving cell, such that the non-serving cell determines the optimal transmitted beam of the terminal device according to the measured reception power. In this way, uplink beam measurement between the terminal device and the non-serving cell is achieved, and a basis is provided for the non-serving cell to provide service for the terminal device.

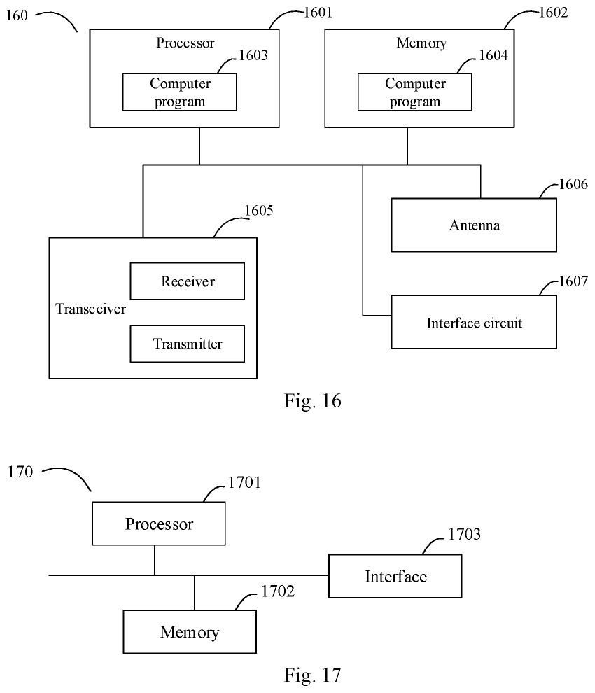

With reference to FIG. 16, FIG. 16 is a schematic structural diagram of another communication apparatus 160 according to an example of the disclosure. The communication apparatus 160 may be a network device, or a terminal device, or a chip, a chip system, or a processor that enables the network device to implement the above method, or a chip, a chip system, or a processor that enables the terminal device to implement the above method. The apparatus may be configured to implement the method described in the above method examples. Reference may be made to the description in the above method examples for details.

The communication apparatus 160 may include one or more processors 1601. The processor 1601 may be a general-purpose processor, a special-purpose processor, etc. For instance, the processor may be a baseband processor or a central processing unit. The baseband processor may be configured to process a communication protocol and communication data. The central processing unit may be configured to control the communication apparatus (for instance, a base station, a baseband chip, a terminal device, a terminal device chip, a DU, or a CU), execute a computer program, and process data of the computer program.

Optionally, the communication apparatus 160 may further include one or more memories 1602. The memory may store a computer program 1604. The processor 1601 executes the computer program 1604, such that the communication apparatus 160 performs the method described in the above method example. Optionally, the memory 1602 may further store data. The communication apparatus 160 and the memory 1602 may be arranged separately or integrated with each other.

Optionally, the communication apparatus 160 may further include a transceiver 1605 and an antenna 1606. The transceiver 1605 may be referred to as a transmission-reception unit, a transmission-reception machine, a transmission-reception circuit, etc., and is configured to achieve a transceiving function. The transceiver 1605 may include a receiver and a transmitter. The receiver may be referred to as a reception machine or a reception circuit, and is configured to achieve a reception function. The transmitter may be referred to as a transmission machine or a transmission circuit, and is configured to achieve a transmission function.

Optionally, the communication apparatus 160 may further include one or more interface circuits 1607. The interface circuit 1607 is configured to receive a code instruction and transmit the code instruction to the processor 1601. The processor 1601 executes the code instruction, such that the communication apparatus 160 performs the method described in the above method example.

In a case that the communication apparatus 160 is a terminal device, the processor 1601 is configured to perform step 43 in FIG. 4; step 52 in FIG. 5, etc. The transceiver 1605 is configured to perform step 21 in FIG. 2, step 31 and step 32 in FIG. 3, step 41 and step 42 in FIG. 4, step 51 in FIG. 5, etc.

In a case that the communication apparatus 160 is a network device, the transceiver 1605 is configured to perform step 101 in FIG. 10, step 111 and step 112 in FIG. 11, step 121 and step 123 in FIG. 12, step 131, step 132 and step 133 in FIG. 13, etc.

In an embodiment, the processor 1601 may include the transceiver configured to achieve reception and transmission functions. For instance, the transceiver may be a transmission-reception circuit, or an interface, or an interface circuit. The transmission-reception circuit, interface or interface circuit configured to achieve the reception and transmission functions may be separated or integrated. The transmission-reception circuit, interface or interface circuit may be configured to read and write codes/data. Alternatively, the transmission-reception circuit, interface or interface circuit may be configured to transmit or transfer a signal.

In an embodiment, the processor 1601 may store a computer program 1603. The computer program 1603 is executed on the processor 1601, such that the communication apparatus 160 may perform the method described in the above method example. The computer program 1603 may be cured in the processor 1601. In this case, the processor 1601 may be implemented by hardware.

In an embodiment, the communication apparatus 160 may include a circuit. The circuit may achieve the transmission or reception or communication function in the above method example. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be manufactured by means of various IC process technologies, such as a complementary metal oxide semiconductor (CMOS), an N-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus according to the above examples may be the network device or the terminal device, which does not limit the scope of the communication apparatus according to the disclosure. A structure of the communication apparatus may not be limited by FIG. 16. The communication apparatus may be an independent device or may be part of a large device. For instance, the communication apparatus may be:
(1) an independent integrated circuit (IC), or a chip, or a chip system, or a subsystem;
(2) a set having one or more ICs, where the IC set may also include a storage component configured to store data and a computer program;
(3) an ASIC, for instance, a modem;
(4) a module that may be embedded in other devices;
(5) a reception machine, a terminal device, an intelligent terminal device, a cellular phone, a radio device, a handset, a mobile unit, a vehicle-mounted device, a network device, a cloud device, an artificial intelligence device, etc.; and
(6) a different device.

In a case that the communication apparatus may be a chip or a chip system, reference may be made to a schematic structural diagram of the chip shown in FIG. 17. The chip shown in FIG. 17 includes a processor 1701 and an interface 1702. The number of processors 1701 may be one or more. The number of interfaces 1702 may be greater than one.

In a case that the chip is configured to achieve functions of the terminal device in the example of the disclosure:
the processor 1701 is configured to perform step 43 in FIG. 4, step 52 in FIG. 5, etc.; and
the interface 1702 is configured to perform step 21 in FIG. 2, step 31 and step 32 in FIG. 3, step 41 and step 42 in FIG. 4, step 51 in FIG. 5, etc.

In a case that the chip is configured to achieve functions of the network device in the example of the disclosure:
the interface 1702 is configured to perform step 101 in FIG. 10, step 111 and step 112 in FIG. 11, step 121 and step 123 in FIG. 12, step 131, step 132 and step 133 in FIG. 13, etc.

Optionally, the chip further includes a memory 1703. The memory 1703 is configured to store a computer program and data that are necessary.

Those skilled in the art may further understand that various illustrative logical blocks and steps listed in the examples of the disclosure may be implemented by electronic hardware, computer software, or a combination of both. Whether the function is achieved by hardware or software depends on specific applications and design requirements of an entire system. Those skilled in the art may achieve the described functions for each particular application through different methods, but such implementation is not considered to be beyond the protection scope of the examples of the disclosure.

The example of the disclosure further provides a communication system. The system includes the communication apparatus as the terminal device and the communication apparatus as the network device in the example of FIG. 15. Alternatively, the system includes the communication apparatus as the terminal device and the communication apparatus as the network device in the example of FIG. 16.

The disclosure further provides a computer-readable storage medium. The computer-readable storage medium stores an instruction. When the instruction is executed by a computer, functions of any one of the above method examples are achieved.

The disclosure further provides a computer program product. When the computer program product is executed by a computer, functions of any one of the above method examples are achieved.

The above examples may be partially or completely achieved by software, hardware, firmware or any combination of them. During implementation with software, the examples may be partially or completely implemented in the form of a computer program product. The computer program product includes one or more computer programs. When the computer program is loaded and executed on the computer, flows or functions according to the examples of the disclosure are partially or completely generated. The computer may be a general-purpose computer, a special-purpose computer, a computer network, or other programmable apparatuses. The computer program may be stored in a computer-readable storage medium or transmitted from a computer-readable storage medium to another computer-readable storage medium. For instance, the computer program may be transmitted from a website, a computer, a server or a data center to another website, another computer, another server or another data center in a wired way (a coaxial cable, an optical fiber, or a digital subscriber line (DSL)) or a wireless way (infrared waves, radio, or microwaves). The computer-readable storage medium may be any available medium that may be accessed by the computer or a data storage device such as a server and a data center that includes one or more available media integrated. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

Those of ordinary skill in the art may understand that numerical symbols such as “first” and “second” involved in the disclosure are only for convenience of description, instead of limiting the scope of the examples of the disclosure, and further indicate a sequence.

“At least one” in the disclosure may also be described as “one or more”, and “a plurality of” may indicate two, three, four or more, which are not limited by the disclosure. In the example of the disclosure, for a technical feature, technical features in the technical feature are distinguished by “first”, “second”, “third”, “A”, “B”, “C”, “D”, etc. The technical features described by the “first”, “second”, “third”, “A”, “B”, “C” and “D” are not in order of succession or order of size. The word “if” used here may be interpreted as “when” or “at the time of” or “in response to determining” or “in a case that”.

The correspondence shown in each table in the disclosure may be configured or predefined. Values of information in each table are only illustrative, and may be configured to be other values, which are not limited by the disclosure. When the correspondence between information and all parameters is configured, not all the correspondences indicated in each table have to be configured. For instance, in the table in the disclosure, the correspondence shown in some rows does not have to be configured. For another instance, appropriate variation and adjustment may be conducted based on the above table, such as splitting and merging. Names of the parameters indicated by headings in the above tables may also be other names that may be understood by a communication apparatus, and values or representations of the parameters may also be other values or representations that may be understood by the communication apparatus. The above tables may also use other data structures during implementation, such as arrays, queues, containers, stacks, linear tables, pointers, linked lists, trees, graphs, structures, classes, heaps and hash tables.

Predefinition in the disclosure may be understood as definition, predefinition, storage, prestorage, prenegotiation, preconfiguration, curing, or prefiring.

Those of ordinary skill in the art may understand that the units and algorithm steps of the instances described in connection with the examples disclosed here can be implemented in electronic hardware, or a combination of computer software and electronic hardware. Whether the functions are implemented in hardware or software depends on specific application and design constraints of the technical solution. Professionals may achieve the described functions for each specific application through different methods, but such implementation is not considered to fall beyond the scope of the disclosure.

It may be further understood that although operations are described in a specific order in the drawings in the examples of the disclosure, it should not be understood that the operations are required to be performed in the specific order or serial order shown or all the operations shown are required to be performed to obtain desired results. Under specific circumstances, multitasking and parallel processing may be advantageous.

Those skilled in the art could easily conceive of other implementation solutions of the disclosure upon consideration of the description and the invention disclosed here. The disclosure is intended to cover any variations, uses or adaptive changes of the disclosure, which follow the general principles of the disclosure and include common general knowledge or conventional technical means not disclosed in the art. The description and the examples are regarded as merely illustrative, and the true scope and spirit of the disclosure are indicated by the following claims.

Those skilled in the art may clearly understand that, for the convenience and conciseness of description, reference may be made to a corresponding process in the above method example for a specific operation process of the system, apparatus and unit described above, which will not be repeated here.

What are described above are merely specific embodiments of the disclosure, but do not limit the protection scope of the disclosure. Any change or substitution that may be easily conceived by any technician familiar with the technical field within the technical scope of the disclosure should fall within the protection scope of the disclosure. Thus, the protection scope of the disclosure should be subject to the protection scope of the claims.

Examples of the disclosure provide a method and apparatus for measuring an uplink beam, which can be applied to the technical field of communication.

In a first aspect, an example of the disclosure provides a method for measuring an uplink beam. The method is performed by a terminal device. The method includes: receiving configuration information, where the configuration information includes a sounding reference signal (SRS) corresponding to a non-serving cell.

Optionally, the configuration information further includes: a path loss reference signal corresponding to the non-serving cell and a spatialRelationInfo corresponding to the non-serving cell.

Optionally, the method further includes:
receiving a first medium access control (MAC) control element (CE) transmitted by a first cell, where the first MAC CE is configured to activate or deactivate a semi-persistent SRS corresponding to the first cell, and the first cell is a serving cell or a non-serving cell.

Optionally, the method further includes:
receiving indication information, where the indication information is configured to indicate a beam to the terminal device; and
deactivating, in response to determining that a second cell corresponding to the indicated beam is different from a third cell currently providing data service for the terminal device, a semi-persistent SRS in an activated state in the third cell.

Optionally, the method further includes:
deactivating, in response to determining that the non-serving cell changes, a semi-persistent SRS in an activated state corresponding to the non-serving cell, where a timing advance corresponding to the non-serving cell and the terminal device is different from a timing advance corresponding to the serving cell and the terminal device.

Optionally, the method further includes:
deactivating, in response to determining that the non-serving cell changes, a semi-persistent SRS in an activated state corresponding to the non-serving cell; or,
deactivating, in response to determining that the non-serving cell changes, a semi-persistent SRS corresponding to a cell list that only includes an identity of the non-serving cell.

A timing advance corresponding to the non-serving cell and the terminal device is the same as a timing advance corresponding to the serving cell and the terminal device, and cells in the cell list are cells that are measured based on the SRS.

Optionally, the method further includes:
determining a cell list corresponding to semi-persistent SRS according to a first MAC CE received.

Optionally, the method further includes:
receiving first downlink control information (DCI) transmitted by the serving cell, where the first DCI is configured to trigger an aperiodic SRS corresponding to the non-serving cell or the serving cell.

Optionally, the method further includes:
receiving a second MAC CE, where the second MAC CE is configured to indicate a selected SRS in a plurality of aperiodic SRSs corresponding to the non-serving cell and the serving cell; and
receiving second DCI transmitted by the serving cell, where the second DCI is configured to trigger the selected SRS.

Optionally, the method further includes:
receiving third DCI transmitted by the third cell, where the third DCI is configured to trigger an aperiodic SRS corresponding to the third cell. The third cell is a serving cell or a non-serving cell.

In a second aspect, an example of the disclosure provides another method for measuring an uplink beam. The method is performed by a network device. The method includes: transmitting configuration information, where the configuration information includes a sounding reference signal (SRS) corresponding to a non-serving cell.

Optionally, the configuration information further includes: a path loss reference signal corresponding to the non-serving cell and a spatialRelationInfo corresponding to the non-serving cell.

Optionally, the method further includes:
transmitting a first medium access control (MAC) control element (CE) based on a time-frequency domain resource corresponding to the non-serving cell or a serving cell. The first MAC CE is configured to activate or deactivate a semi-persistent SRS corresponding to any one of the non-serving cell and the serving cell.

Optionally, the method further includes:
transmitting first downlink control information (DCI) based on a time-frequency domain resource corresponding to the serving cell, where the first DCI is configured to trigger an aperiodic SRS corresponding to the non-serving cell or the serving cell.

Optionally, the method further includes:
transmitting a second MAC CE, where the second MAC CE is configured to indicate a selected SRS in a plurality of aperiodic SRSs corresponding to the non-serving cell and the serving cell; and
transmitting second DCI based on a time-frequency domain resource corresponding to the serving cell, where the second DCI is configured to trigger the selected SRS.

Optionally, the method further includes:
transmitting third DCI based on a time-frequency domain resource corresponding to the non-serving cell or the serving cell, where the third DCI is configured to trigger an aperiodic SRS corresponding to any one of the serving cell and the non-serving cell.

In a third aspect, an example of the disclosure provides a communication apparatus. The communication apparatus has some or all functions of a terminal device in the method according to the first aspect. For instance, the communication apparatus may have functions in some or all examples of the disclosure, or may have a function of independently implementing any one of the examples of the disclosure. The function may be achieved by hardware or by executing corresponding software with hardware. The hardware or software includes one or more units or modules corresponding to the above functions.

In a fourth aspect, an example of the disclosure provides another communication apparatus. The communication apparatus has some or all functions of a network device in the method according to the second aspect. For instance, the communication apparatus may have functions in some or all examples of the disclosure, or may have a function of independently implementing any one of the examples of the disclosure. The function may be achieved by hardware or by executing corresponding software with hardware. The hardware or software includes one or more units or modules corresponding to the above functions.

In a fifth aspect, an example of the disclosure provides a communication apparatus. The communication apparatus includes a processor. The processor performs the method according to the first aspect when calling computer programs in a memory.

In a sixth aspect, an example of the disclosure provides a communication apparatus. The communication apparatus includes a processor. The processor performs the method according to the second aspect when calling computer programs in a memory.

In a seventh aspect, an example of the disclosure provides a communication apparatus. The communication apparatus includes a processor and a memory. The memory stores computer programs. When the processor executes the computer programs, the communication apparatus performs the method according to the first aspect.

In an eighth aspect, an example of the disclosure provides a communication apparatus. The communication apparatus includes a processor and a memory. The memory stores computer programs. When the processor executes the computer programs, the communication apparatus performs the method according to the second aspect.

In a ninth aspect, an example of the disclosure provides a communication apparatus. The apparatus includes a processor and an interface circuit. The interface circuit is configured to receive code instructions and transmit the code instructions to the processor. The processor is configured to execute the code instructions such that the apparatus performs the method according to the first aspect.

In a tenth aspect, an example of the disclosure provides a communication apparatus. The apparatus includes a processor and an interface circuit. The interface circuit is configured to receive code instructions and transmit the code instructions to the processor. The processor is configured to execute the code instructions such that the apparatus performs the method according to the second aspect.

In an eleventh aspect, an example of the disclosure provides a communication system. The system includes the communication apparatus according to the third aspect and the communication apparatus according to the fourth aspect. Alternatively, the system includes the communication apparatus according to the fifth aspect and the communication apparatus according to the sixth aspect. Alternatively, the system includes the communication apparatus according to the seventh aspect and the communication apparatus according to the eighth aspect. Alternatively, the system includes the communication apparatus according to the ninth aspect and the communication apparatus according to the tenth aspect.

In a twelfth aspect, an example of the disclosure provides a computer-readable storage medium. The computer-readable storage medium is configured to store instructions used by the terminal device. When the instructions are executed, the method according to the first aspect is implemented.

In a thirteenth aspect, an example of the disclosure provides a computer-readable storage medium. The computer-readable storage medium is configured to store instructions used by the network device. When the instructions are executed, the method according to the second aspect is implemented.

In a fourteenth aspect, the disclosure further provides a computer program product including computer programs. When the computer program product is executed on a computer, the computer performs the method according to the first aspect.

In a fifteenth aspect, the disclosure further provides a computer program product including computer programs. When the computer program product is executed on a computer, the computer performs the method according to the second aspect.

In a sixteenth aspect, the disclosure provides a chip system. The chip system includes at least one processor and an interface, and is configured to enable a terminal device to achieve functions involved in the first aspect, for instance, a function of determining or processing at least one of data and information involved in the method. In a possible design, the chip system further includes a memory. The memory is configured to store computer programs and data necessary for the terminal device. The chip system may include chips, or may include a chip and other discrete devices.

In a seventeenth aspect, the disclosure provides a chip system. The chip system includes at least one processor and an interface, and is configured to enable a network device to achieve functions involved in the second aspect, for instance, a function of determining or processing at least one of data and information involved in the method. In a possible design, the chip system further includes a memory. The memory is configured to store computer programs and data necessary for the network device. The chip system may include chips, or may include a chip and other discrete devices.

In an eighteenth aspect, the disclosure provides computer programs. When the computer programs are executed on a computer, the computer performs the method according to the first aspect.

In a nineteenth aspect, the disclosure provides computer programs. When the computer programs are executed on a computer, the computer performs the method according to the second aspect.

1. A method for measuring an uplink beam, performed by a terminal device and comprising:
receiving configuration information, wherein the configuration information comprises a sounding reference signal (SRS) corresponding to a non-serving cell.

2. The method according to claim 1, wherein the configuration information further comprises: a path loss reference signal corresponding to the non-serving cell and a spatialRelationInfo corresponding to the non-serving cell.

3. The method according to claim 1, further comprising:
receiving a first medium access control (MAC) control element (CE) transmitted by a first cell, wherein the first MAC CE is configured to activate or deactivate a semi-persistent SRS corresponding to the first cell, and the first cell is a serving cell or a non-serving cell.

4. The method according to claim 1, further comprising:
receiving indication information, wherein the indication information is configured to indicate a beam to the terminal device; and
deactivating, in response to determining that a second cell corresponding to the indicated beam is different from a third cell currently providing data service for the terminal device, a semi-persistent SRS in an activated state in the third cell.

5. The method according to claim 1, further comprising:
deactivating, in response to determining that the non-serving cell changes, a semi-persistent SRS in an activated state corresponding to the non-serving cell, wherein a timing advance corresponding to the non-serving cell and the terminal device is different from a timing advance corresponding to the serving cell and the terminal device.

6. The method according to claim 1, further comprising:
deactivating, in response to determining that the non-serving cell changes, a semi-persistent SRS in an activated state corresponding to the non-serving cell; or,
deactivating, in response to determining that the non-serving cell changes, a semi-persistent SRS corresponding to a cell list that only comprises an identity of the non-serving cell, wherein
a timing advances corresponding to the non-serving cell and the terminal device is the same as a timing advance corresponding to the serving cell and the terminal device, and cells in the cell list are cells that are measured based on the SRS.

7. The method according to claim 6, further comprising:
determining a cell list corresponding to semi-persistent SRS according to a first MAC CE received.

8. The method according to claim 1, further comprising:
receiving first downlink control information (DCI) transmitted by the serving cell, wherein the first DCI is configured to trigger an aperiodic SRS corresponding to the non-serving cell or the serving cell.

9. The method according to claim 1, further comprising:
receiving a second MAC CE, wherein the second MAC CE is configured to indicate a selected SRS in a plurality of aperiodic SRSs corresponding to the non-serving cell and the serving cell; and
receiving second DCI transmitted by the serving cell, wherein the second DCI is configured to trigger the selected SRS.

10. The method according to claim 1, further comprising:
receiving third DCI transmitted by the third cell, wherein the third DCI is configured to trigger an aperiodic SRS corresponding to the third cell, and the third cell is a serving cell or a non-serving cell.

11. A method for measuring an uplink beam, performed by a network device and comprising:
transmitting configuration information, wherein the configuration information comprises a sounding reference signal (SRS) corresponding to a non-serving cell.

12. The method according to claim 11, wherein the configuration information further comprises: a path loss reference signal corresponding to the non-serving cell and a spatialRelationInfo corresponding to the non-serving cell.

13. The method according to claim 11, further comprising: transmitting a first medium access control (MAC) control element (CE) based on a time-frequency domain resource corresponding to the non-serving cell or a serving cell, wherein the first MAC CE is configured to activate or deactivate a semi-persistent SRS corresponding to any one of the non-serving cell and the serving cell.

14. The method according to claim 11, further comprising:
transmitting first downlink control information (DCI) based on a time-frequency domain resource corresponding to the serving cell, wherein the first DCI is configured to trigger an aperiodic SRS corresponding to the non-serving cell or the serving cell.

15. The method according to claim 11, further comprising:
transmitting a second MAC CE, wherein the second MAC CE is configured to indicate a selected SRS in a plurality of aperiodic SRSs corresponding to the non-serving cell and the serving cell; and
transmitting second DCI based on a time-frequency domain resource corresponding to the serving cell, wherein the second DCI is configured to trigger the selected SRS.

16. The method according to claim 11, further comprising:
transmitting third DCI based on a time-frequency domain resource corresponding to the non-serving cell or the serving cell, wherein the third DCI is configured to trigger an aperiodic SRS corresponding to any one of the serving cell and the non-serving cell.

17.-32. (canceled)

33. A communication apparatus, comprising a processor and a memory, wherein the memory stores computer programs, and the processor executes the computer programs stored in the memory, such that the apparatus performs: receiving configuration information, wherein the configuration information comprises a sounding reference signal (SRS) corresponding to a non-serving cell.

34. A communication apparatus, comprising a processor and a memory, wherein the memory stores computer programs, and the processor executes the computer programs stored in the memory, such that the apparatus performs the method according to claim 11.

35.-36. (canceled)

37. A non-transitory computer-readable storage medium, being configured to store instructions, wherein when the instructions are executed, the method according to claim 1 is implemented.

38. A non-transitory computer-readable storage medium, being configured to store instructions, wherein when the instructions are executed, the method according to claim 11 is implemented.
